(19) United States
(12) Patent Application Publication
(10) Pub. No.: US 2012/0021880 A1
(43) Pub. Date: Jan. 26, 2012

(54) Tool Changer

(75) Inventor: Michael Grupp, Friedberg (DE)

(73) Assignee: Delaware Capital Formation, Inc., Wilmington, DE (US)

(21) Appl. No.: 13/175,011

(22) Filed: Jul. 1, 2011

Related U.S. Application Data
(63) Continuation of application No. PCT/DE2010/001517, filed on Dec. 27, 2010.

(30) Foreign Application Priority Data
Jan. 6, 2010 (DE) 102010004085.1

(51) Int. Cl. B23Q 3/155

(52) U.S. Cl. 483/69

(57) ABSTRACT

A tool changer has two changer module parts that can be coupled with one another. Each module part includes an attachment part and at least one coupling part associated with the attachment part. An adapter plate, including multiple fastening areas, is equipped with a desired number of changer module parts. The adapter plate is removable associated with each of the changer module parts on the attachment part side.

### CROSS-REFERENCE TO RELATED APPLICATIONS

This application is a continuation of International Application No. PCT/DE2010/001517, filed Dec. 27, 2010, which claims priority to German Application No. 10 2010 004 085.1, filed Jan. 6, 2010. The disclosures of the above applications are incorporated herein by reference.

### FIELD

The disclosure relates to a tool changer and, more particularly, to a tool changer including an adapter plate with multiple fastening areas to removably receives a desired number of changer module parts.

### BACKGROUND

Tool changers are particularly used on the ends of robot arms. The tools situated on the tool changers are typically gripping tools, welding tongs, vacuum grippers, clamping devices, or similar devices.

Tool changers are fundamentally known and are used in greatly varying designs. Reference is made solely for exemplary purposes to the following publications, for such tool changers: DE 100 50 619 B4, DE 10 2007 016 300 A1, DE 10 2005 031 803 A1, and DE 20 2005 010 693 U1. Generally, such tool changers have the following construction. The tool changers have a two-part formation that include parts that are implemented as connectable to and disconnectable from one another using locking elements (coupling parts) to join with one another. One part is fastened, using connection elements, onto a handling device (such as a robot arm). The other part, also provided with connection elements, is implemented as a holder for a tool, to be associated with the tool changer. With respect to differing stresses to be managed by the tools, different dimensioned production series of tool changers are provided. The tool changers are selected based upon the stress exerted onto the tool changers. The tool changers are installed or fastened on one side to the robot arm and on the other side to the tool. It is decisive that the two-part tool changer, which is separable per se, is sufficient for the respective expected stress in its connection area. Further, tool changers have been developed and used that contain three identical changer parts. The parts are situated in a triangular composite and can be coupled with one another, assembled into a unit. Thus, practically three individual smaller tool changers are associated with a correspondingly adapted gripper, that is also correspondingly dimensioned to be stronger. The gripper is sufficient for the specified stress. In this example, the load to be absorbed is distributed into thirds to the individual tool changers. An auxiliary element is also provided in this previously known “triple changer” (see FIG. 6), that forms one unit. This auxiliary element is also only intended for a specific load. The entirety is connected to a significant production and maintenance expenditure, both in the case of the above-mentioned serial provision and also in the case of the mentioned triple changer, since all of these tool changers are intended for a specific load case or a specific load range.

### SUMMARY

It is an object of the disclosure, proceeding from a tool changer of the last-mentioned type, to ensure an improvement with respect to manufacturing and provision expenditure.

This object is achieved according to the present disclosure by a tool changer that comprises two changer module parts that can be coupled with one another. Each module part includes an attachment part and at least one coupling part associated with the attachment part. An adapter plate, including multiple fastening areas, is equipped with a desired number of changer module parts. The adapter plate is removably associated with each of the changer module parts on the attachment part side. The attachment parts are each implemented with a polygonal peripheral contour to provide extensive possible continuous assembly of the attachment parts on their adapter plate. The peripheral contour of the attachment parts is implemented as a symmetrical, in particular, rotationally-symmetrical polygon. The peripheral contour of the attachment parts is implemented as a polygon. The attachment parts are provided with fasteners. The fasteners are situated in a specific pattern. The adapter plates are provided with a repeating pattern of fasteners corresponding to the attachment part pattern. The attachment parts peripheral contour includes formations for their mutual fixing. The attachment parts, with their insertable coupling parts, include connections aligned with one another for the supply of an operating media. At least one attachment parts is provided with a supply line module for the operating media. The adapter plate includes operating media ducts and connections for the attachment parts. The adapter plates are connectable to one another using a disconnectable operating medium supply line, which leads to the tool.

Nothing changes in the basic conception of a tool changer, but its association with both the handling device (robot) and also with the tool does change. In other words, in each case an adapter plate is to be removably situated between the elements of the changer, namely a receptacle part and an insertion part, referred to as the coupling parts. The associated configuration or support elements, namely the robot arm on one side and the tool on the other side, and the adapter plates are provided with a repeating pattern for connection elements corresponding to the individual configuration patterns of the connection elements (referred to as attachment parts). Thus, it is possible to situate one or more single changers on the adapter plates having appropriately large dimensions and fixing them in a suitable way to adapt to a predefined stress. Repeating pattern is understood as a pattern template for the connection elements, which contains the pattern template of the attachment parts with the coupling parts. Thus, multiple tool changers can each be associated, using their parts and in a number corresponding to the stress, with the adapter plates and fastened to them, but optionally also only use one tool changer. The provision or usage of tool changers intended for specific stresses as explained above and heretofore practiced is thus dispensed with according to the disclosure. For the producers and sellers of such tool changers according to the disclosure, to a certain degree, this advantageously means that they must only produce one tool changer size, which can be supplemented using identical changer sizes and can be assembled on the respective adapter plate.

The tool changer, which is variable according to the disclosure and therefore as a function of stress, and the advantageous refinements are explained in greater detail on the basis of the drawings of exemplary embodiments.

Further areas of applicability will become apparent from the description provided herein. The description and specific examples in this summary are intended for purposes of illustration only and are not intended to limit the scope of the present disclosure.

### DRAWINGS

The disclosed clamping device and its advantageous embodiments are described in greater detail below with reference to drawings of exemplary embodiments that are viewed from the flank side.

FIG. 1 is an elevation view partly in section of a changer unit.

FIG. 2 is an elevation view of a changer unit positioned on a robot arm and a gripper tool.

FIG. 3 is a top plan view of an adapter plate with changer units.

FIG. 4 is a top plan view of the changer configurations in another embodiment.

FIG. 5 is a cross section view of a structural detail.

FIG. 6 is a plan view of an attachment-side of the upper and lower parts of a known tool changer.

### DETAILED DESCRIPTION

The following is to be noted beforehand of the definition of the terms used hereafter. The tool changer as a whole is referred to as a changer module. The coupled parts are referred to as changer module parts 1, 2. The load-absorbing parts, which can be engaged with one another in a formfitting way, are referred to as coupling parts 4. The support elements are referred to as attachment parts 3. The changer module parts 1, 2 are to be fastened onto the adapter plates 5. The adapter plates 5 are, in turn, to be fastened onto the robot arm, on one side, and on the tool, on the other side.

With reference to FIG. 6, the tool changer, which is presumed to be the prior art, includes two changer module parts 1, 2 that can be coupled with one another. Each part is formed from an attachment part 3 and at least one coupling part 4 associated with the attachment part 3. The “at least” takes into consideration that, as shown in FIG. 6, the attachment parts 3 can be equipped with three coupling parts 4, for example.

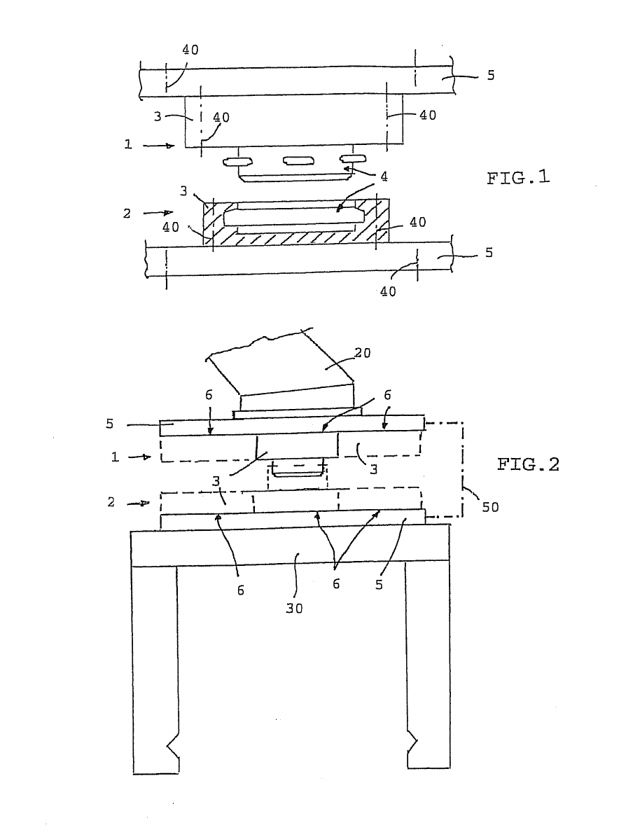

With reference to FIG. 1, the coupling parts 4, situated on their attachment parts 3, are an insert part, on the one hand and a receptacle part, on the other hand. The insert part is inserted and locked, in a suitable way, into the receptacle part.

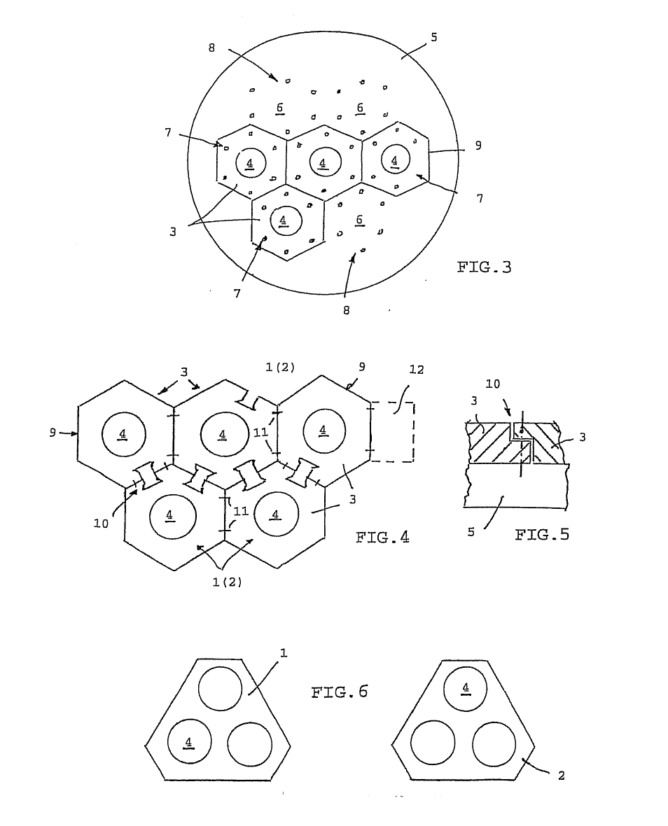

In the changer module according to the disclosure, it is essential, with reference to FIGS. 3, 4, that the changer module parts 1, 2 each have an adapter plate 5. The adapter plate 5 is removably associated with the module parts 1, 2 on the attachment part side. The adapter plates 5 have multiple fastening areas 6 to be equipped with a desired number of changer module parts 1, 2.

The parts of the changer module parts 1, 2, that are illustrated on a handling device 20 (robot arm) and on a tool 30 (gripper) in FIG. 2, are also structurally relatively small units. Each unit is designed solely for a relatively small stress absorption. The units more or less represent fundamental units in the present case. If a greater carrying capacity is required, a larger changer module designed, so it can be stressed more, does not have to be used. Rather, it is only necessary to supplement the existing basic unit with one or more identical changer module parts 1, 2, depending on the carrying capacity requirement. This requires an adapter plate 5 with a correspondingly large blank portion for receiving additional changer modules. The adapter plates 5 must be dimensioned, in their area size, for the attachment of multiple changer module parts 1, 2 adjacent to one another as seen in FIG. 3.

In order to be able to keep the adapter plates 5 as small as possible, the attachment parts 3 are each implemented with a polygonal peripheral contour 9. The contour 9 enables the most extensive possible continuous assembly of the attachment parts 3 on the adapter plates 5. For this purpose, implementing the peripheral contour 9 of the attachment parts 3 as a symmetrical polygon, preferably a hexagon (like a honeycomb), comes into consideration with reference to FIGS. 3 and 4.

In this context, fasteners 40 are provided on the attachment parts 3. The fasteners 40 are situated in a specific pattern 7 on the attachment parts 3. The adapter plates 5 are equipped with a repeating pattern 8 of fasteners 40 that correspond to the attachment part pattern 7, as schematically shown in FIG. 3.

Furthermore, the attachment parts 3 can be provided, on their peripheral contour 9, with formations 10 for their mutual fixing together with one another. Small undercut grooves may be used as the formations 10, for example, as schematically shown in FIG. 4. The corresponding shape-adapted connectors can be inserted into the formations 10, only a few of which are illustrated in FIG. 4.

In order to be able to actuate the two changer module parts 1, 2, depending on their design, of a changer module, which can be coupled with one another, these parts must be able to be charged with an actuating medium suitable for this purpose, hydraulically, pneumatically, or also electrically. In the present case, multiple changer module parts are configured on the adapter plates 5. The attachment parts 3 are provided with connections 11 that align with one another for the supply of their operating media. A suitable supply module 12 is expediently provided on only one of the attachment parts 3. In this way, the supply module 12 supplies an entire group of changer module parts 1, 2 (see FIG. 4).

However, it is also possible to equip the required adapter'plates 5, on which the attachment parts 3 are seated, with operating medium ducts and connections (not shown separately) for the attachment parts 3. It should be noted that typically only one of the adapter plates 5 is required for this purpose. Namely the plate on which the attachment parts 3 are attached that contain the coupling parts 4 that are actuated or moved for locking purposes, for example.

With reference to FIG. 5, the attachment parts 3 can be implemented to overlap one another, at least partially, on their edges in the area where the fixing to the adapter plates 5 is performed. In addition, the adapter plates 5 can also be used so that the operating medium supplied on the support element side of the adapter plate 5 is supplied in the closed or locked position of the changer of the other adapter plate 5. This enables actuation of the tool 30 fixed to the plates 5. Such a connection, via an operating medium supply line 50, between the adapter plates 5 is only indicated by dot-dash lines in FIG. 2.

The present disclosure has been described with reference to a preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A tool changer comprising:
two changer module parts that can be coupled with one another, each module part including an attachment part and at least one coupling part associated with the attachment part; and
an adapter plate including multiple fastening areas is equipped with a desired number of changer module parts, the adapter plate is removably associated with each of the changer module parts on the attachment part side.

2. The tool changer according to claim 1, wherein the attachment parts are each implemented with a polygonal peripheral contour to provide extensive possible continuous assembly of the attachment parts on their adapter plate.

3. The tool changer according to claim 2, wherein the peripheral contour of the attachment parts is implemented as a symmetrical, in particular rotationally-symmetrical polygon.

4. The tool changer according to claim 2, wherein the peripheral contour of the attachment parts is implemented as a polygon.

5. The tool changer according to claim 1, wherein the attachment parts are provided with fasteners, the fasteners are situated in a specific pattern, the adapter plates are provided with a repeating pattern of fasteners corresponding to the attachment part pattern.

6. The tool changer according to claim 2, wherein the attachment parts peripheral contour include formations for their mutual fixing.

7. The tool changer according to claim 1, wherein the attachment parts, with their insertable coupling parts, include connections aligned with one another for the supply of operating media.

8. The tool changer according to claim 7, wherein at least one attachment parts is provided with a supply line module for the operating media.

9. The tool changer according to claim 1, wherein the adapter plate includes operating media ducts and connections for the attachment parts.

10. The tool changer according to claim 1, wherein the adapter plates are connectable to one another using a disconnectable operating medium supply line, which leads to the tool.
